(19) United States
(12) Patent Application Publication
(10) Pub. No.: US 2012/0079912 A1
(43) Pub. Date: Apr. 5, 2012

(54) SPEED REGULATION METHOD AND DEVICE

(75) Inventors: Carmelo Leone, Freising (DE); Frank Drews, Rothenbach (DE); Jürgen Bäumler, Furth (DE); Thomas Brandt, Edelsfeld (DE)

(73) Assignee: CONTI TEMIC MICROELECTRONIC GMBH, Nurnberg (DE)

(21) Appl. No.: 13/319,827

(22) PCT Filed: May 5, 2010
(86) PCT No.: PCT/EP2010/056067

§ 371 Date: Dec. 16, 2011

(30) Foreign Application Priority Data
May 15, 2009 (DE) 10 2009 021 587.5

(51) Int. Cl. G05G 1/38

(52) U.S. Cl. 74/560

(57) ABSTRACT

A method for regulating motor vehicle speed by a pedal system having a force resetting device, including a pedal lever with a pedal return spring which can move the pedal lever to its zero position, an electric motor pivotable about a center of rotation which, when energized, can apply a resetting force to the pedal lever in the zero position direction, a motor return spring resets the electric motor in the zero position direction of the electric motor, and a control unit for controlling the electric motor. When the electric motor is de-energized, the pedal return spring, the motor return spring and a hysteresis element generate a passive pedal characteristic curve (PPCC). The PPCC can be changed by energizing the electric motor, and is variable additively at maximum with the available torque of the electric motor and substractively in the region of the spring constant of the motor return spring.

### CROSS REFERENCE TO RELATED APPLICATIONS

This application is the U.S. National Phase Application of PCT International Application No. PCT/EP2010/056067, filed May 5, 2010, which claims priority to German Patent Application No. 10 2009 021 587.5, filed May 15, 2009, the contents of such applications being incorporated by reference herein.

### FIELD OF THE INVENTION

The invention relates to a method for regulating the speed of a motor vehicle according to a method for regulating the speed in a motor vehicle by means of a pedal system having a force resetting device which is integrated in a housing, and to a device for carrying out the method.

### BACKGROUND OF THE INVENTION

In the automobile industry there is an increasing trend to assist the driver of the vehicle in terms of driving safety, driving comfort and driving efficiency. Examples of this are cruise control systems and lane-keeping systems. In this context, the driving behavior is influenced in an assisting fashion on the basis of measured vehicle parameters and ambient parameters.

In particular, pedal systems with an integrated force resetting device, referred to as force feedback systems, function simultaneously during the influencing of the speed as cruise controllers, speed delimiters or, via the speed control, as a system for maintaining a minimum distance from the vehicle traveling ahead. However, as soon as the driver of the vehicle intervenes in the control by braking, engaging the clutch or by abrupt acceleration, the system is switched off.

In a normal case, for the purpose of increasing the speed the foot of the vehicle driver applies a force to the accelerator pedal counter to a return spring. In the force feedback system, this force is counteracted by an additional resetting force which is generated, for example, by an electromechanical actuator. The magnitude of the resetting force can depend here on the magnitude of the deviation from a speed setpoint value.

Such a method and such a device are known from DE 196 20 929 A1, which is incorporated by reference. In this context, when an adjustment element exceeds a predefined value a resetting force which is proportional to the deviation from the predefined value is generated at the accelerator pedal as a power control element. Simultaneously, at all times the driver maintains full control of the vehicle since he does not give up control via the power control element at any time. This serves exclusively to maintain driving safety, but does not contribute to the driving comfort.

### SUMMARY OF THE INVENTION

An aspect of the present invention aims to provide a method for regulating the speed of a motor vehicle which not only improves the driving safety but also at the same time improves the driving comfort and the driving efficiency.

This is achieved according to aspects of the invention a method for regulating the speed in a motor vehicle by means of a pedal system having a force resetting device which is integrated in a housing, comprising a pedal lever for converting the driver's request to speed, wherein the pedal lever can be pivoted about a center of rotation (P) from a zero position (PN) of the pedal lever to an end position (PE) of the pedal lever, a pedal return spring which can move the pedal lever to its zero position (PN), an electric motor, which can be pivoted about a center of rotation (M) from a zero position (MN) of the electric motor to an end position (ME) of the electric motor, and which in the energized state can apply a resetting force F to the pedal lever in the direction of the zero position (PN) thereof, wherein the respective rotational direction from the end position (PE, ME) to the zero position (PN, MN) is identical for the pedal lever and the electric motor, a drive pulley which is connected to the electric motor by means of a shaft which applies the resetting force (F) to the pedal lever by means of a drive roller which is arranged eccentrically on the drive pulley, wherein, when the resetting force (F) is applied to the pedal lever, the drive roller merely bears on the pedal lever a motor return spring for resetting the electric motor in the direction of the zero position (MN) of the electric motor, a control unit for controlling the electric motor, wherein the functional relationship between a force which acts on the pedal lever and the angle of the pedal lever between the zero position (PN) and the end position (PE) is described by a pedal characteristic curve (PK1, PK2, PK3, . . . ), wherein when the electric motor is de-energized, the pedal return spring, a hysteresis element on the pedal lever and the motor return spring generate a passive pedal characteristic curve (PK1), and the passive characteristic curve (PK1) can be changed by energizing the electric motor.

In the method for regulating the speed of a motor vehicle according to aspects of the invention, an opposing force acts on the foot of the driver of the vehicle at a pedal lever. This force is generated by a force resetting device. The force resetting device comprises essentially a pedal lever which can be pivoted about a center of rotation from a zero position to an end position, and a pedal return spring which can move the pedal lever to its zero position. Furthermore, the force resetting device comprises an electric motor which can be pivoted about a center of rotation from a zero position to an end position and which in the energized state can apply a resetting force to the pedal lever in the direction of the zero position thereof, and a motor return spring for resetting the de-energized electric motor to the zero position thereof.

The functional relationship between a force which acts on the pedal lever and the angle of the pedal lever between the zero position and the end position is described by a pedal characteristic curve. A pedal return spring, a hysteresis element, in particular on the pedal lever, and a motor return spring generate what is referred to as a passive pedal characteristic curve, in particular in a de-energized electric motor. In a pedal characteristic curve, the forward movement characteristic curve, which corresponds to the profile of the opposing force as the pedal angle increases in the direction of the end position of the pedal lever, lies above the return movement characteristic curve, with the result that a hysteresis effect is produced. The hysteresis is generated by a hysteresis element.

In particular, the passive characteristic curve can be changed by energizing the electric motor. Specifically, the electric motor can be energized in both directions with the result that the passive force which is generated by springs can be both increased and decreased. The electric motor can apply resetting force to the pedal lever only in the direction of the zero position of the pedal lever. If the electric motor is energized in the other direction, it is structurally ensured that the pedal lever cannot be deflected in the direction of the completely open throttle.

The pedal characteristic curve can be reduced to a minimum pedal characteristic curve below the passive characteristic curve by decoupling the motor return spring in the direction of the end position of the electric motor by correspondingly energizing the electric motor. In this context, the minimum characteristic curve is then generated exclusively by the pedal return spring and the hysteresis element; neither the motor return spring nor the electric motor itself apply a force to the pedal lever in this case.

In particular, between the zero position and the end position of the pedal lever any point between the passive characteristic curve and the minimum pedal characteristic curve can be implemented by correspondingly energizing the electric motor in the region between the de-energized state and energization during which the electric motor is in its end position. It is, for example, possible to imagine that the current of the electric motor is set to a fixed value in such a way that the opposing force which acts on the pedal lever in the de-energized state as a result of the motor return spring is reduced by a fixed absolute value. The new characteristic curve which is produced in this way is then below the passive characteristic curve, while having the same gradient. However, the electric motor can also be energized in such a way that the gradient of the characteristic curve which is produced in this way varies in a desired way.

On the other hand, the passive pedal characteristic curve can, in particular, also be increased up to a maximum pedal characteristic curve. The maximum pedal characteristic curve is defined by the maximum achievable torque of the electric motor. In this context, a corresponding maximum resetting force then acts on the pedal lever through corresponding energization of the electric motor in the direction of its zero position and therefore in the direction of the zero position of the pedal lever.

If, as in the case of the reduction of the passive characteristic curve up to the minimum characteristic curve, it is also advantageously possible here for any point between the passive characteristic curve and the maximum pedal characteristic curve to be implemented by correspondingly energizing the electric motor in the range between the de-energized state and the maximum possible current. It is also possible here for the gradient of the curve which is newly produced between the zero position and the end position of the pedal lever to correspond to the gradient of the passive characteristic curve or else to vary in any desired way.

In the case of a deviation from the normal operating state of the motor vehicle, it is possible that in the case of a setpoint position between the zero position and the end position of the pedal lever an abrupt increase, predefined by a control unit, in the resetting force a jump in force can be applied to the pedal lever in the direction of its zero position in order to alert the driver of the vehicle to this deviation. The duration of the jump in force can be of any desired shortness but can also last until the normal operating state of the motor is restored. In particular, a chronologically limited reduction in the pedal characteristic curve can take place before the above-mentioned setpoint position, which reduction remains, however, above the minimum pedal characteristic curve. As a result, the haptic impression of the jump in force on the foot of the driver of the vehicle is increased further.

In addition, in the case of a setpoint position of the pedal lever in particular in the vicinity of the end position of the pedal lever, the resetting force on the pedal lever, predefined by the control unit, is controlled by corresponding energization of the electric motor in such a way that a kickdown functionality is implemented. In this context, when the accelerator pedal is depressed completely by a jump in force near to the end position of the pedal lever, the driver of the vehicle is given the impression of travel with a completely open throttle.

A further aspect of the present invention aims to provide a device for carrying out the method according to for regulating the speed in a motor vehicle by means of a pedal system having a force resetting device which is integrated in a housing, comprising a pedal lever for converting the driver's request to speed, wherein the pedal lever can be pivoted about a center of rotation (P) from a zero position (PN) of the pedal lever to an end position (PE) of the pedal lever, a pedal return spring which can move the pedal lever to its zero position (PN), an electric motor, which can be pivoted about a center of rotation (M) from a zero position (MN) of the electric motor to an end position (ME) of the electric motor, and which in the energized state can apply a resetting force F to the pedal lever in the direction of the zero position (PN) thereof, wherein the respective rotational direction from the end position (PE, ME) to the zero position (PN, MN) is identical for the pedal lever and the electric motor, a drive pulley which is connected to the electric motor by means of a shaft which applies the resetting force (F) to the pedal lever by means of a drive roller which is arranged eccentrically on the drive pulley, wherein, when the resetting force (F) is applied to the pedal lever, the drive roller merely bears on the pedal lever a motor return spring for resetting the electric motor in the direction of the zero position (MN) of the electric motor, a control unit for controlling the electric motor, wherein the functional relationship between a force which acts on the pedal lever and the angle of the pedal lever between the zero position (PN) and the end position (PE) is described by a pedal characteristic curve (PK1, PK2, PK3, . . . ), wherein when the electric motor is de-energized, the pedal return spring, a hysteresis element on the pedal lever and the motor return spring generate a passive pedal characteristic curve (PK1), and the passive characteristic curve (PK1) can be changed by energizing the electric motor.

This is achieved according to aspects of the invention by means of a device having the features of having a force resetting device which is integrated in a housing, comprising a pedal lever for converting the driver's request to speed, wherein the pedal lever can be pivoted about a central rotation (P) from a zero position (PN) of the pedal lever to an end position (PE) of the pedal lever, a pedal return spring which can move the pedal lever to its zero position (PN), an electric motor which can be pivoted about a central rotation (M) from a zero position (MN) of the electric motor to an end position (ME) of the electric motor, and which, in the energized state, can apply a resetting force to the pedal lever in the direction of the zero position (PN) thereof, wherein the respective rotational direction from the end position (PE, ME) to the zero position (PN, MN) is identical for the pedal lever and the electric motor, a drive pulley which is connected to the electric motor by means of a shaft and which applies the resetting force to the pedal lever by means of a drive roller which is arranged eccentrically on the drive pulley, wherein, when the resetting force (F) is applied to the pedal lever, the drive roller merely bears on the pedal lever, a motor return spring for resetting the electric motor in the direction of the zero position (MN) of the electric motor, a control unit for controlling the electric motor, wherein the electric motor comprises a rotor and a stator, wherein the stator is arranged on the shaft of the electric motor between the rotor and the drive pulley, wherein, when the electric motor is de-energized, the pedal return spring, a hysteresis element on the pedal lever and the motor return spring generate a passive pedal characteristic curve (PK1), and the passive characteristic curve (PK1) can be changed by energizing the electric motor.

The device according to aspects of the invention for regulating the speed of a motor vehicle describes a compact pedal system for use in a motor vehicle having a housing and having a force resetting device which is integrated to the housing. The resetting force on the pedal lever in the direction of the zero position thereof is generated, in particular, by energizing an electric motor. The electric motor comprises a stator and a rotor which is arranged on a shaft. In addition, a drive pulley is arranged on the shaft of the electric motor, which drive pulley can apply the resetting force to the pedal lever by means of a drive roller which is arranged eccentrically on the drive pulley. In particular, the stator on the shaft of the electric motor is arranged between the rotor and the drive pulley. This has the advantage that effect of the bending torque on the rotor, which acts on the shaft through the drive pulley, is small when the resetting force is applied to the pedal lever since the rotor is arranged on the side of the stator lying opposite the drive pulley. As a result, the air gap between the stator and the rotor is generally not changed and the actuation capability of the electric motor is not adversely affected.

### BRIEF DESCRIPTION OF THE DRAWINGS

The invention is best understood from the following detailed description when read in connection with the accompanying drawings. Included in the drawings is the following figures:

FIG. 1 shows a passive and a minimum pedal characteristic curve;

FIG. 2 shows a pedal characteristic curve between the passive and minimum pedal characteristic curves with a constant gradient;

FIG. 3 shows a pedal characteristic curve between the passive and minimum pedal characteristic curves with a variable gradient;

FIG. 4 shows pedal characteristic curves above the passive characteristic curve with a constant gradient and with a variable gradient;

FIG. 5 shows a freely configured pedal characteristic curve above and below the passive pedal characteristic curve with constant gradients in certain sections;

FIG. 6 shows a pedal characteristic curve with a force reduction before a jump in force;

FIG. 7 shows a pedal characteristic curve with a kickdown functionality,

FIG. 8 shows a pedal system with a drive unit for influencing the pedal characteristic curve.

### DETAILED DESCRIPTION OF THE PREFERRED EMBODIMENTS

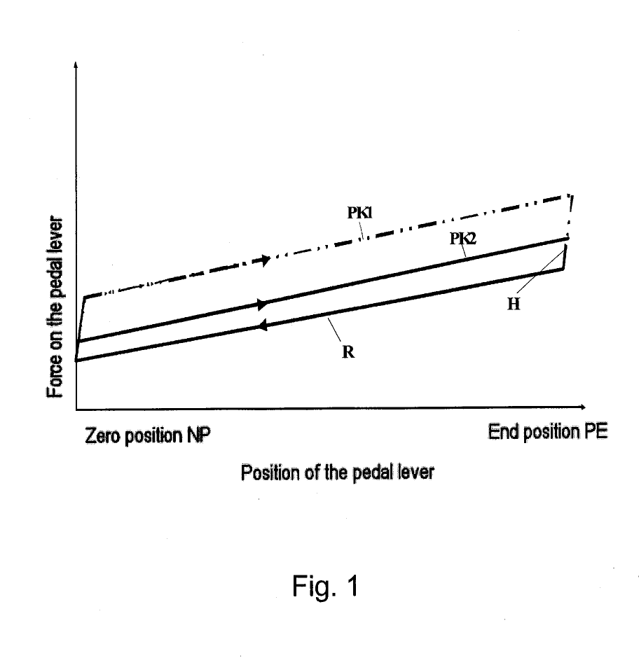

In order to increase the speed of a vehicle, the driver of the vehicle applies a force to a pedal lever 1. As the angle by which the pedal lever 1 is deflected from the zero position and with respect to the end position of the pedal lever becomes larger, the speed of the vehicle increases. In order to give the driver of the vehicle the sensation that he is controlling the speed, an opposing force counter to the force of the foot of the driver of the vehicle is increased at the pedal lever 1 as the pedal lever angle increases. This opposing force is generated, in particular, by a pedal return spring 2, a motor return spring 8 and a hysteresis element 5. As a rule, these devices are implemented by means of mechanical springs. These can be, in particular, tension springs and/or torsion springs. If the force which is applied to the pedal lever 1 by the driver of the vehicle and the opposing force which is generated by the return spring 2, the motor return spring 8 and the hysteresis element 5 are in equilibrium, the driver of the vehicle is given the sensation, in particular on a level roadway, that he is moving forward at a constant speed. The characteristic curve of a pedal lever 1 shows the profile of the force which acts on the pedal lever, as a function of the pedal angle. In FIG. 1, the dot-dash outgoing-movement line of the characteristic curve PK1 between the zero position and the end position of the pedal lever represents an increase in speed. The initial opposing force at the zero position and the gradient of the pedal characteristic curve PK1 are determined by the selection of the pedal return spring 2, the motor return spring 8 and the hysteresis element 5, by the material constants thereof, and these should as far as possible remain constant during the entire service life of the vehicle.

If the driver of the vehicle wishes to decrease the speed of the vehicle, he reduces the force on the pedal lever 1. The opposing force with which the pedal lever 1 acts on the foot of the driver of the vehicle is now reduced by the absolute value which is generated by the hysteresis element 5. This reduction of the opposing force when there is a reversal of the pedal angle is illustrated by what is referred to as the hysteresis line H. The opposing force of the return movement characteristic curve R is now applied only by the pedal return spring 2 and the motor return spring 8. When there is a request to reduce the speed, the driver of the vehicle decreases the force on the pedal lever 1. The opposing force which is applied by the return springs 2, 8 causes the pedal lever 1 to remain in contact with the foot of the driver of the vehicle, and the driver of the vehicle is given the sensation that he is actively controlling the vehicle in the direction of a relatively low speed. The control circuit of the driver and the pedal lever as the speed control variable and the information transmitting instrument remains closed.

The pedal characteristic curve in FIG. 1, which is represented essentially by the dot-dash forward-movement line, by the hysteresis line H and by the return movement line R is the passive pedal characteristic curve PK1. What is referred to as the minimum pedal characteristic curve PK2 shows the minimum opposing force and the minimum gradient of a characteristic curve. This minimum pedal characteric curve PK2 must not be undershot for safety reasons. It ensures that the time in which the pedal lever 1 is moved from its possible end position PE to its zero position NP up to the pedal angle 0 does not exceed a specific value (insofar as the driver's foot is lifted off).

The reduction of the passive pedal characteristic curve PK1 to the minimum pedal characteristic curve PK2 is implemented, in particular, by neutralizing or decoupling the motor return spring 8 in the direction of the end position ME of the electric motor 4 by correspondingly energizing the electric motor 4. In this context, the minimum pedal characteristic curve PK2 is then generated exclusively by the pedal return spring 2 and the hysteresis element 5; neither the motor return spring 8 nor the electric motor 4 itself apply a force to the pedal lever 1 in this case.

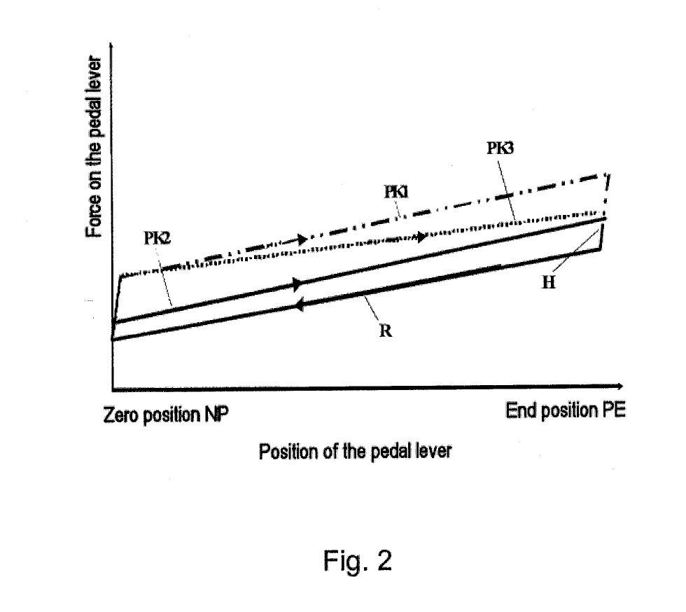

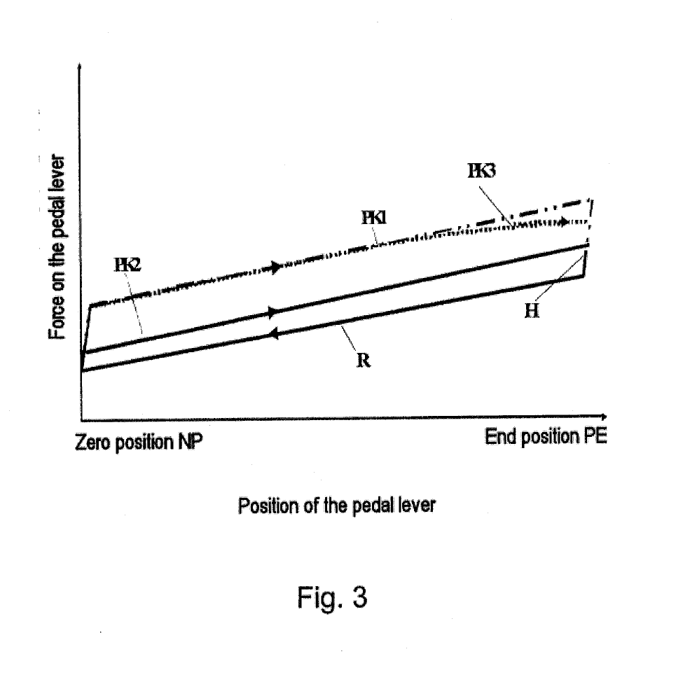

In particular, between the zero position PN and the end position PE of the pedal lever 1 any point between the passive pedal characteristic curve PK1 and the minimum pedal characteristic curve PK2 can be implemented by correspondingly energizing the electric motor 4 in the region between the de-energized state and energization during which the electric motor 4 is in its end position ME. FIG. 2 shows a pedal characteristic curve PK3 with a forward movement line which is reduced compared to the passive characteristic curve PK1 and has a constant but relatively small gradient. In contrast thereto, FIG. 3 shows a pedal characteristic curve PK3 with a reduced forward movement line with a variable gradient, wherein the gradient decreases toward the end position PE of the pedal lever 1.

The passive pedal characteristic curve PK1 can, on the other hand, also be increased in particular to a maximum pedal characteristic curve. The maximum pedal characteristic curve is defined by the maximum achievable torque of the electric motor 4. In this context, a corresponding maximum resetting force acts on the pedal lever 1 by correspondingly energizing the electric motor 4 in the direction of its zero position MN and therefore in the direction of the zero position PN of the pedal lever 1.

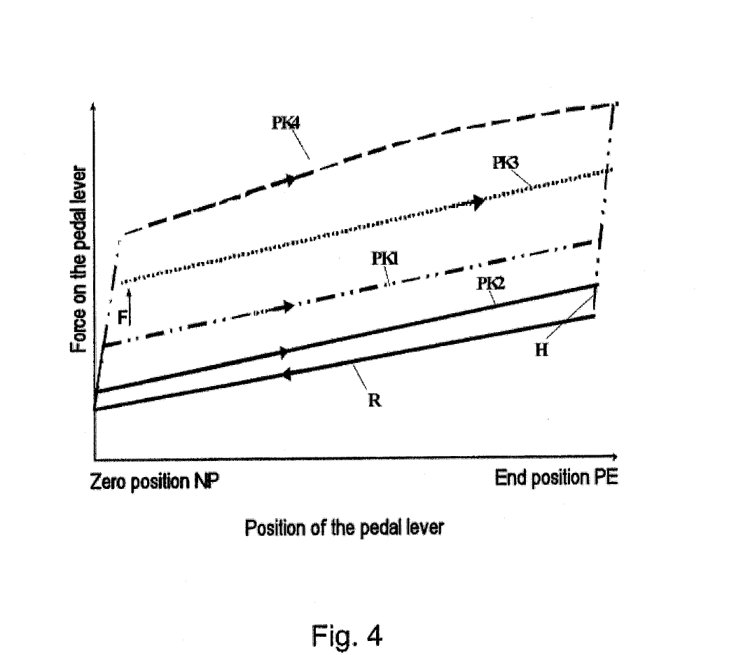

As in the case of the reduction of the passive characteristic curve up to the minimum characteristic curve, it is also advantageously possible here for any point between the passive characteristic curve and the maximum pedal characteristic curve to be implemented by correspondingly energizing the electric motor in the range between the de-energized state and the maximum possible current. FIG. 4 shows, for example, a pedal characteristic curve PK3 which is increased in the entire range between the zero position PN and the end position PE of the pedal lever 1 while maintaining the gradient with respect to the passive characteristic curve PK1. For this purpose, the electric motor 4 is energized in such a way that a constant resetting force F is added to the opposing force which acts on the pedal lever 1 by means of the pedal return spring 2, the motor return spring 8 and the hysteresis element 5. The gradient of the pedal characteristic curve PK4 which is also shown in FIG. 4 can vary between the zero position PN and the end position PE of the pedal lever 1.

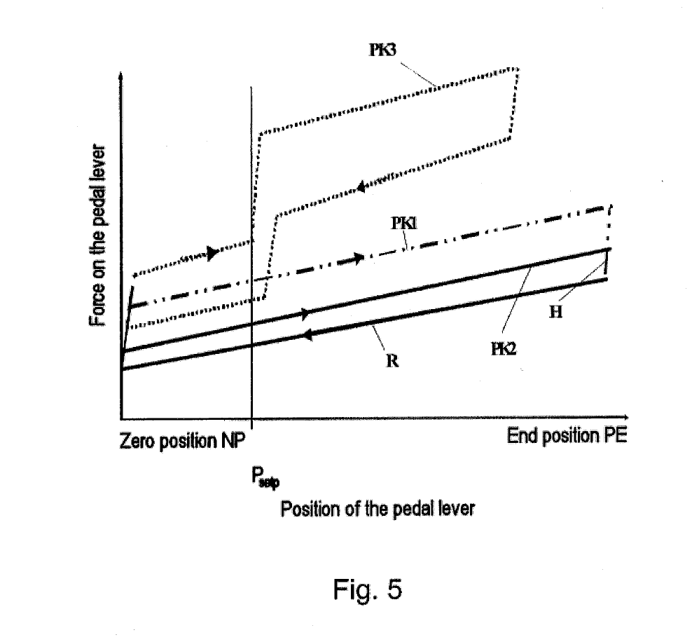

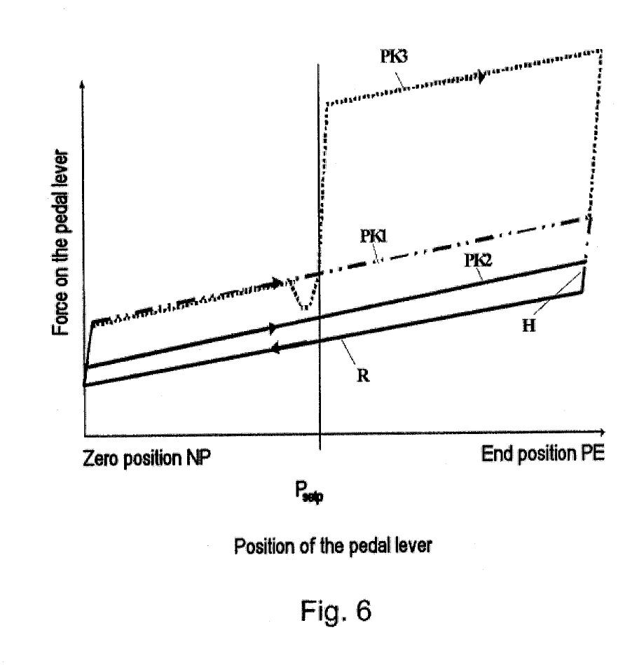

FIG. 5 shows a pedal characteristic curve PK3 in which a resetting force is added starting from a pedal angle Pₛₑₜₚ, and is also maintained above a setpoint position Pₛₑₜₚ of the pedal lever 1. This case can occur, for example, when the driver of the vehicle has selected an economical driving program and the rotational speed of the motor above a setpoint position Pₛₑₜₚ of the pedal lever is no longer in the environmentally friendly range. The resetting force is not reduced until the rotational speed of the motor corresponds to the economical driving program again. Before the resetting force is increased at the setpoint position Pₛₑₜₚ of the pedal lever 1 in FIG. 6, the force counter to the foot of the driver of the vehicle is briefly reduced in order to reinforce further the impression of the subsequent increase in force.

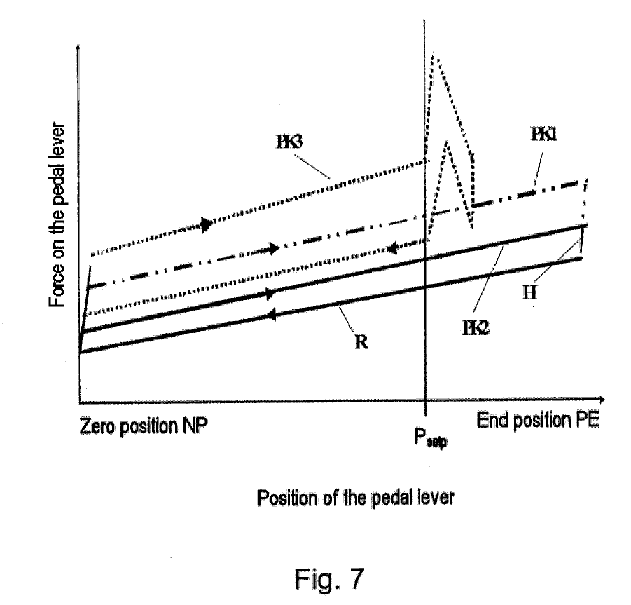

In addition, as shown in FIG. 7, in the case of a setpoint position Pₛₑₜₚ of the pedal lever 1, in particular in the vicinity of the end position PE of the pedal lever 1, the resetting force F which is predefined by the control unit 10 and is applied to the pedal lever 1 by correspondingly energizing the electric motor 4 is controlled in such a way that a kickdown functionality is implemented. In this case, when the pedal lever 1 is depressed quickly, a jump in force, that is to say an abrupt increase in the resetting force, is triggered, and is quickly reduced again after the resetting force is overcome and the pedal angle increases.

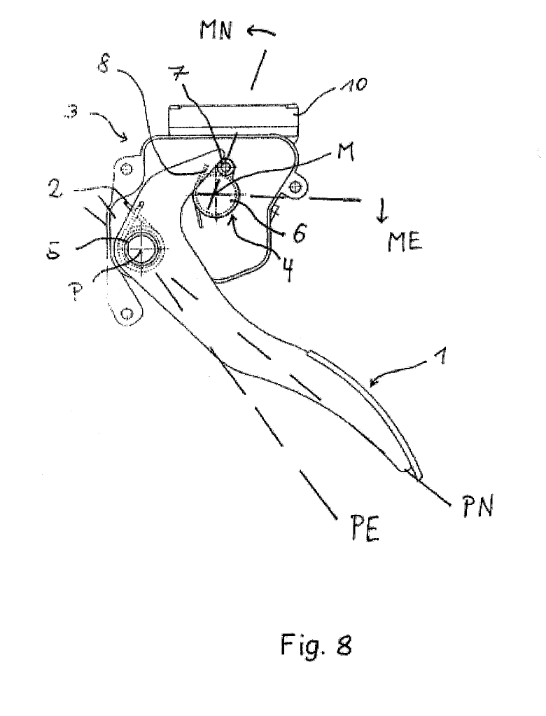

FIG. 8 shows a compact pedal system for regulating the speed, wherein a force resetting device is integrated to the housing 3. The pedal system comprises essentially a pedal lever 1 for converting the driver's request to speed. An electric motor 4, in particular a torque motor, as a further component of the pedal system can, in the energized state, bring about a resetting force on the pedal lever 1 in the direction of a reduction in speed. A drive pulley 6 is mounted on the electric motor 4, on the shaft thereof, said drive pulley 6 being able to apply the resetting force F to the pedal lever 1 by means of a drive roller 7. A control unit 10 for controlling the electric motor 4 is also integrated to the housing 3.

The electric motor 4 comprises, in a manner which is not shown, essentially a stator and a rotor which is connected to a shaft which can rotate in the stator. The stator is arranged on the shaft between the rotor and the drive pulley 6. The drive roller 7, which applies the resetting force F to the pedal lever 1 when the electric motor 4 is energized, is arranged here on the drive pulley 6, for example screwed or pressed. The influence of the bending torque on the air gap between the rotor and the stator which acts on the shaft of the electric motor 4 when the resetting force is applied is generally very small in this case. The functional capability of the electric motor 4 is accordingly ensured in this arrangement even when there are relatively high resetting forces.

FIG. 8 shows a pedal system with a pedal lever 1 in its zero position PN. This means that the foot of the driver of the vehicle on the pedal lever 1 does not apply any force in the direction of increasing the speed, and the motor of the vehicle rotates at the idling speed. The pedal lever 1 can be pivoted about the center of rotation P, specifically from a zero position PN up to an end position PE, which means when translated to the rotational speed of the motor from idling to fully open throttle. In this case, a leg spring as the pedal return spring 2 is arranged at the center of rotation P of the pedal lever 1 in such a way that it presses the pedal lever 1 to its zero position PN. As an alternative, a linearly acting spring would also be conceivable as the pedal lever return spring 2, in particular outside the center of rotation P. The electric motor 4 can be pivoted about its center of rotation M, specifically from its end position ME to its zero position MN. In the described case, the centers of rotation P and M of the pedal lever 1 and of the electric motor 4 are positionally separated. However, a pedal system in which the two centers of rotation P and M coincide would be perfectly possible.

By decoupling the motor return spring 8 in the direction of the end position ME of the electric motor 4, the passive pedal characteristic curve PK1 can be reduced to a minimum pedal characteristic curve PK2 by correspondingly energizing the electric motor 4, wherein the minimum pedal characteristic curve PK2 is then generated by the pedal return spring 2 and the hysteresis element 5.

### LIST OF REFERENCE NUMBERS

1 Pedal lever
2 Pedal return spring
3 Housing
4 Electric motor
5 Hysteresis element
6 Drive pulley
7 Drive roller
8 Motor return spring
9 Interface
10 Control unit
11 Rotor
12 Stator
13 Shaft of the electric motor
14 Monitoring element
15 Pin
F Resetting force
M Center of rotation of the electric motor
MN Zero position of the electric motor
ME End position of the electric motor
P Center of rotation of the pedal lever
PN Zero position of the pedal lever
PE End position of the pedal lever
PK1 Passive pedal characteristic curve
PK2 Minimum pedal characteristic curve
PK Pedal characteristic curve
Pₛₑₜₚ Setpoint position of the pedal lever
R Return movement characteristic curve
H Hysteresis characteristic curve

1.-9. (canceled)

10. A method for regulating the speed in a motor vehicle by a pedal system having a force resetting device which is integrated in a housing, comprising:
converting the driver's request to speed with a pedal lever, wherein the pedal lever can be pivoted about a center of rotation (P) from a zero position (PN) of the pedal lever to an end position (PE) of the pedal lever;
moving the pedal lever to its zero position (PN) with a pedal return spring;
an electric motor, which can be pivoted about a center of rotation (M) from a zero position (MN) of the electric motor to an end position (ME) of the electric motor, and which in the energized state can apply a resetting force F to the pedal lever in the direction of the zero position (PN) thereof, wherein the respective rotational direction from the end position (PE, ME) to the zero position (PN, MN) is identical for the pedal lever and the electric motor;
connecting a drive pulley to the electric motor by a shaft which applies the resetting force (F) to the pedal lever by a drive roller which is arranged eccentrically on the drive pulley, wherein, when the resetting force (F) is applied to the pedal lever, the drive roller merely bears on the pedal lever a motor return spring for resetting the electric motor in the direction of the zero position (MN) of the electric motor; and
controlling the electric motor with a control unit, wherein the functional relationship between a force which acts on the pedal lever and the angle of the pedal lever between the zero position (PN) and the end position (PE) is described by a pedal characteristic curve (PK1, PK2, PK3, . . . ),
wherein when the electric motor is de-energized, the pedal return spring, a hysteresis element on the pedal lever and the motor return spring generate a passive pedal characteristic curve (PK1), and the passive characteristic curve (PK1) can be changed by energizing the electric motor.

11. The method for regulating the speed as claimed in claim 10, wherein the passive pedal characteristic curve (PK1) between the zero position (PN) and the end position (PE) of the pedal lever can be reduced to a minimum pedal characteristic curve (PK2) by decoupling the motor return spring in the direction of the end position (ME) of the electric motor by correspondingly energizing the electric motor, wherein the minimum pedal characteristic curve (PK2) is then generated by the pedal return spring and the hysteresis element.

12. The method for regulating the speed as claimed in claim 11, wherein between the zero position (PN) and the end position (PE) of the pedal lever any point between the passive characteristic curve (PK1) and the minimum pedal characteristic curve (PK2) can be implemented by correspondingly energizing the electric motor in the region between the de-energized state and energization during which the electric motor is in its end position (ME).

13. The method for regulating the speed as claimed in claim 10, wherein between the zero position (PN) and the end position (PE) of the pedal lever the passive pedal characteristic curve (PK1) can be increased up to a maximum pedal characteristic curve which is defined by the maximum torque of the electric motor, by virtue of the fact that a corresponding resetting force (F) acts on the pedal lever through corresponding energization of the electric motor in the direction of its zero position (MN).

14. The method for regulating the speed as claimed in claim 13, wherein between the zero position (PN) and the end position (PE) of the pedal lever any point between the passive characteristic curve (PK1) and the maximum pedal characteristic curve can be implemented by correspondingly energizing of the electric motor in the region between the de-energized state and the maximum possible current.

15. The method for regulating the speed as claimed in claim 10, wherein in the case of a setpoint position (Pₛₑₜₚ) between the zero position (PN) and the end position (PE) of the pedal lever a jump in force which is predefined by the control unit is applied to the pedal lever in the direction of its zero position (PN), which jump in force is intended to alert the driver of the vehicle to a deviation from the normal operating state of the motor vehicle.

16. The method for regulating the speed as claimed in claim 15, wherein before the setpoint position (Pₛₑₜₚ) a chronologically limited reduction in the pedal characteristic curve (PK) is carried out.

17. The method for regulating the speed as claimed in claim 10, wherein in the case of a setpoint position (Pₛₑₜₚ) of the pedal lever between the zero position (PN) and the end position (P) of the pedal lever the resetting force (F) which is predefined by the control unit can be applied to the pedal lever in such a way that a kickdown functionality is implemented.

18. A pedal system for carrying out the method as claimed in claim 10, having a force resetting device which is integrated in a housing, comprising:
a pedal lever for converting the driver's request to speed;
wherein the pedal lever can be pivoted about a central rotation (P) from a zero position (PN) of the pedal lever to an end position (PE) of the pedal lever;
a pedal return spring which can move the pedal lever to its zero position (PN);
an electric motor which can be pivoted about a central rotation (M) from a zero position (MN) of the electric motor to an end position (ME) of the electric motor, and which, in the energized state, can apply a resetting force to the pedal lever in the direction of the zero position (PN) thereof, wherein the respective rotational direction from the end position (PE, ME) to the zero position (PN, MN) is identical for the pedal lever and the electric motor;
a drive pulley which is connected to the electric motor by a shaft and which applies the resetting force to the pedal lever by a drive roller which is arranged eccentrically on the drive pulley, wherein, when the resetting force (F) is applied to the pedal lever, the drive roller merely bears on the pedal lever;
a motor return spring for resetting the electric motor in the direction of the zero position (MN) of the electric motor; and
a control unit for controlling the electric motor,
wherein the electric motor comprises a rotor and a stator, wherein the stator is arranged on the shaft of the electric motor between the rotor and the drive pulley, wherein, when the electric motor is de-energized, the pedal return spring, a hysteresis element on the pedal lever and the motor return spring generate a passive pedal characteristic curve (PK1), and the passive characteristic curve (PK1) can be changed by energizing the electric motor.
